(19) United States
(12) Patent Application Publication
(10) Pub. No.: US 2015/0126601 A1
(43) Pub. Date: May 7, 2015

(54) LIQUID COMPOSITIONS COMPRISING A SUSPENDED INSECT GROWTH REGULATOR

(71) Applicant: ADM ALLIANCE NUTRITION INC., Decatur, IL (US)

(72) Inventor: Bruce Moechnig, Quincy, IL (US)

(21) Appl. No.: 14/400,708

(22) PCT Filed: May 10, 2013
(86) PCT No.: PCT/US13/40464

§ 371 Date: Nov. 12, 2014

Related U.S. Application Data
(60) Provisional application No. 61/648,806, filed on May 18, 2012.

(51) Int. Cl. A01N 25/04; A01N 37/36

(52) U.S. Cl. CPC A01N 25/04; A01N 37/36
USPC 514/549

(57) ABSTRACT

Liquid compositions comprising suspended, solid insect growth regulators are disclosed. Processes for producing such liquid compositions and uses thereof in animal feeds are also disclosed.

### TECHNICAL FIELD

The present invention is directed towards insect growth regulators. In particular, the present invention is directed towards suspensions of solid insect growth regulators for use in liquid animal feeds.

### BACKGROUND OF THE INVENTION

Insect growth regulators (IGRs) are used in animal feeds to help control insects such as flies. Methoprene is one insect growth regulator that may be used to control flies in cattle. The methoprene may be in a solid or liquid form when fed to cattle. The methoprene passes through the digestive tract of cattle and ends up in the manure, where flies lay their eggs. The methoprene prevents the fly larvae from developing into adult flies.

While methoprene is an effective insect growth regulator, it is classified by the Environmental Protection Agency (EPA) as a biochemical pesticide and, thus, its use requires EPA regulatory approval. While dry forms of methoprene have been used for many years, liquid versions of methoprene for use in liquid feeds are not as widely used.

Thus, what is needed is a suspension of a solid methoprene that may be used in liquid animal feeds.

### SUMMARY OF THE INVENTION

In each of its various embodiments, the present invention fulfills this need and discloses solid forms of insect growth regulators that may be used in liquid animal feeds. Uses of the solid insect growth regulators in liquid animal feeds are also disclosed.

In one embodiment, a liquid composition comprises a polar diluent, a carrier, and a solid form of insect growth regulator. The solid form of the insect growth regulator is suspended in the polar diluent.

In another embodiment, a liquid composition comprises a polar diluent, a suspending agent, water, a carrier, and a solid form of methoprene suspended in the liquid composition.

In yet an additional embodiment, a process for suspending a solid form of methoprene in a liquid comprises placing a liquid in a container, and mixing a suspending agent and the solid form of the methoprene with the liquid. The solid form of the methoprene is suspended in the liquid to achieve a concentration of active ingredient of 0.5-1.5% of the liquid.

### DETAILED DESCRIPTION OF THE INVENTION

In the present application, including the claims, other than in the operating examples or where otherwise indicated, all numbers expressing quantities or characteristics are to be understood as being modified in all instances by the term “about”. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein is only incorporated to the extent that no conflict arises between that incorporated material and the existing disclosure material

Disclosed herein are liquid compositions comprising suspensions of solid IGRs, as well as processes of producing the same. Uses of the suspended, solid IGRs in liquid animal feeds for controlling insects are also disclosed.

The liquid compositions may comprise one or more solid IGRs, at least one polar diluent, at least one carrier, at least one suspending agent, and water.

In one embodiment, the insect growth regulator is methoprene, which is substantially similar to a naturally occurring juvenile insect hormone. Methoprene interferes with an insect's life cycle by preventing the insect from reaching maturity and reproducing. Methoprene is effective against horn flies, mosquitoes, beetles, tobacco moths, sciarid flies, fleas (eggs and larvae), fire ants, pharaoh ants, midge flies, and Indian meal moths.

In another embodiment, the IGR may be selected from the group consisting of fenoxycarb, kinoprene, pyriproxifen, methoprene, hydroprene, and combinations of any thereof. The IGR may be present in the liquid composition at amounts ranging from 0.25-15%, 0.5-5%, or 0.95-1.05%.

In an additional embodiment, the polar diluent may be selected from the group consisting of glycerol, propylene glycol, ethylene glycol, isosorbide, isosorbide derivatives, sorbitol, erythritol, carbohydrates, high HLB emulsifiers, polyhydric alcohols, and combinations of any thereof.

In a further embodiment, the carrier may be a crop meal selected from the group consisting of soybean meal, corn meal, linseed meal, cottonseed meal, canola meal, rape seed meal, sunflower meal, an oilseed meal, alfalfa leaf meal, and combinations of any thereof. The crop meal may be solvent extracted to remove oil.

In another embodiment, the carrier may be a molasses and/or the crop meal. In a further embodiment, the carrier may be selected from the group consisting of beet sugar molasses, citrus molasses, hemicellulose extract, starch molasses, cane sugar molasses, corn steep liquor, liquid fermentation co-products, fermentation liquors, condensed distillers solubles, corn syrup, soy molasses, and combinations of any thereof.

In an embodiment, the liquid compositions of the present invention may further comprise a suspending agent which may be selected from the group consisting of clay, kaolinite, smectite, vermiculite, aluminosilicate clay, attapulgite clay, pectin, xanthan gum, microcrystalline cellulose, carrageenan, acacia, agar, guar, locust bean gum, tragacanth, starch, or any combinations thereof.

In another embodiment, the liquid compositions described herein are substantially free of a hydrophobic agent that may be selected from the group consisting of a fat, a vegetable oil, a mineral oil, or combinations of any thereof. By being substantially free, the liquid compositions of the present invention do not have any added fat, vegetable oil, mineral oil, or combinations of any thereof. In this manner, any of the IGRs of the present invention may not form an emulsion with such fat, vegetable oil, mineral oil, or combinations of any thereof in the liquid compositions.

The following exemplary, non-limiting examples are provided to further describe the embodiments presented herein. Those having ordinary skill in the art will appreciate that variations of these Examples are possible within the scope of the invention.

### EXAMPLE 1

A liquid composition including about 1% methoprene as an insect growth regulator (IGR) was prepared in a batch process. There were no chemical reactions involved in the process which included weighing, mixing, and packaging of the liquid composition. The formulation process included: weighing and delivering the liquid ingredients into a mixing tank; blending the liquid ingredients in the tank to obtain a homogenous mix for a period of time, such as about 2 minutes; weighing the dry ingredients (including the IGR) and adding such dry ingredients to the liquid in the mixing tank; blending the dry ingredients with the liquid ingredients for a period of time, such as about 15 minutes, to achieve a uniform, stable suspension of the dry ingredients in the liquid; and weighing, packaging, and labeling of the liquid composition. The liquid composition may be packed in drums, plastic containers, or other desired liquid holding device.

The liquid ingredients included molasses as a carrier, glycerin as a polar diluent, propylene glycol as a polar diluent, water, and combinations of any thereof. The dry ingredients included the solid form of the methoprene, xanthan gum as a suspending agent, attapulgite clay as a suspending agent, solvent extracted linseed meal as a carrier, and combinations of any thereof.

### EXAMPLE 2

The procedure of Example 1 was used to produce a 1% liquid methoprene liquid composition. The composition included: a carrier comprising cane molasses, beet molasses, or a combination thereof at a concentration of no more than 80% or from 1 to 86%; a polar diluent comprising glycerol, propylene glycol (1,2-propanediol), or a combination thereof at a concentration or no more than about 45% or from 1 to 46%; water at an amount of no more than about 5% or from 0.5 to 5%; xanthan gum as a suspending agent at an amount of no more than about 0.4% or between 0.01-0.4%; attipulgite clay as a suspending agent at an amount of no more than about 4% or between 0.5-4%; an oilseed meal (solvent extracted) as a carrier at an amount of no more than about 10% or between 0.5-10%; and about 9.55% of a 10.5% s-methoprene (isopropyl (2E, 4E, 7S)-11-methoxy-3,7,11-trimethyl-2,4-dodecadienoate) as the IGR, such that the liquid composition comprises about 1% methoprene, between 0.9-1.1% methoprene, or between 0.5-1.5% methoprene. The methoprene was dried onto a precipitated silica carrier (R-ST 10 brand methoprene available from B2E Corporation of Schaumburg, Ill.). The liquid composition may comprise between about 8.60-10.50% of the solid methoprene, with the remaining amount of the liquid composition comprising between about 87.7-93.2% of the other, inert ingredients.

The liquid composition of this example is a dark brown liquid, and has an odor typical of molasses. The liquid composition had a pH of about 5.27, which may range from about 4.5 to about 6.0, as measured by mixing 10 grams of the liquid composition in 100 ml of deionized water and measuring the pH. The liquid composition had a viscosity of about 2000 cps at 80° F., which may range from about 1400 cps to about 4000 cps, as measured with a Brookfield viscometer with a #3 spindle. The liquid composition had a density of about 1.3 g/cc, which may range from about 0.8 g/cc to about 1.8 g/cc.

Table 1 shows 5 additional formulations of liquid compositions including about 1% methoprene produced in accordance with the present invention.

| | | Propylene | | | | | | Methoprene | Viscosity | Viscosity |
|---|---|---|---|---|---|---|---|---|---|---|
| Molasses | Glycerol | Glycol | Gum | Water | Clay | Salt | Silica | (10.5%) | (ambient | (elevate |
| % | % | % | % | % | % | % | % | % | temp.) | temp. |
| 45.22 | | 45.23 | | | 2 | 1 | | 9.55 | 3235 | 2400 |
| 45.22 | 45.23 | | 0.1 | 2.9 | | | | 9.55 | 1990 | 1440 |
| 85.45 | 5.0 | | 0.1 | 2.9 | | | | 9.55 | 4410 | 3850 |
| 85.45 | | 5.0 | 0.1 | 2.9 | | | | 9.55 | 4375 | 3415 |
| 45.22 | 45.23 | | | | | | 0.5 | 9.55 | 5075 | 3195 |

### EXAMPLE 3

Glycerin and molasses were weighed and placed into a mixing vessel. The mixing vessel was placed on a floor-mounted mixing device and a spindle speed of 912 rpm was used to mix the glycerin, molasses, and added water for 2 minutes. The water was added for between 10 to 20 seconds. After 2 minutes of mixing, the appropriate amount of 10.5% methoprene was added to the mixing liquid to achieve a 1% concentration of methoprene in the liquid composition. The methoprene was added from between about 10 to about 164 seconds. After the methoprene was added, xanthan gum was slowly added to the mixing liquid to prevent clumping. The xanthan gum was added from between 10 to about 21 seconds. After the xanthan gum was added, mixing was continued for 5 minutes. The resultant suspension showed no loss of active ingredient or settling of the active ingredient over a 32 week period when stored under ambient conditions.

### EXAMPLE 4

The liquid compositions including the IGRs of the present invention are used to prevent the development of horn flies in the manure of beef or dairy cattle, and/or to prevent the emergence of horn flies from the manure of treated cattle including breeding, lactating, and/or dairy cattle and calves.

For effective horn fly control, the liquid compositions of the present invention should be mixed with liquid animal feeds to achieve a target rate of about 1.13 mg of the IGR/100 lbs of the animal's body weight per day, or about 34 mg of the IGR/100 lbs of the animal body's weight per month.

The present invention has been described with reference to certain exemplary and illustrative embodiments, compositions and uses thereof. However, it will be recognized by persons having ordinary skill in the art that various substitutions, modifications or combinations of any of the exemplary embodiments may be made without departing from the scope of the invention. Thus, the invention is not limited by the description of the exemplary and illustrative embodiments, but rather by the appended claims

1. A liquid composition comprising:
a polar diluent;
a carrier; and
a solid form of insect growth regulator suspended in the polar diluent.

2. The liquid composition of claim 1, wherein the liquid composition is substantially free of a hydrophobic agent.

3. The liquid composition of claim 1, further comprising a suspending agent.

4. The liquid composition of claim 3, wherein the suspending agent is selected from the group consisting of a clay, a gum, and combinations thereof.

5. The liquid composition of claim 1, wherein the carrier is selected from the group consisting of molasses, a crop meal, and a combination thereof.

6. The liquid composition of claim 1, wherein the insect growth regulator is selected from the group consisting of fenoxycarb, kinoprene, pyriproxifen, methoprene, hydroprene, and combinations of any thereof.

7. The liquid composition of claim 1, wherein the insect growth regulator is methoprene.

8. The liquid composition of claim 1, wherein the insect growth regulator is present at a concentration of between about 0.25% to about 15%.

9. The liquid composition of claim 1, wherein the insect growth regulator is present at a concentration of between about 0.5% to 5%.

10. The liquid composition of claim 1, wherein the insect growth regulator is present at a concentration of between about 0.95-1.05%.

11. The liquid composition of claim 1, wherein the polar diluent is selected from the group consisting of glycerin, propylene glycol, and a combination thereof.

12. The liquid composition of claim 1, further comprising water.

13. The liquid composition of claim 1, wherein the insect growth regulator is present at 0.5-1.5% in the liquid composition.

14. A liquid composition comprising:
a polar diluent;
a suspending agent;
water;
a carrier; and
a solid form of methoprene suspended in the liquid composition.

15. The liquid composition of claim 13, wherein the polar diluent is selected from the group consisting of glycerin, propylene glycol, and a combination thereof.

16. The liquid composition of claim 13, wherein the suspending agent is selected from the group consisting of a clay, a gum, and combinations thereof.

17. The liquid composition of claim 13, wherein the carrier is an oilseed meal, molasses, or a combination thereof.

18. The liquid composition of claim 13, wherein:
the carrier is present at 1 to 86%;
the polar diluent is present at 1 to 46%;
the solid form of the methoprene is present at 8.6-10.5%.

19. The liquid composition of claim 13, wherein the methoprene is present in the liquid composition at 0.9-1.1%.

20. (canceled)

21. A process for suspending a solid form of methoprene in a liquid, the process comprising:
placing a liquid in a container;
mixing a suspending agent and the solid form of the methoprene with the liquid, such that the solid form of the methoprene is suspended in the liquid at an amount of 0.5-1.5% of the liquid.
